(19) United States
(12) Patent Application Publication
(10) Pub. No.: US 2013/0207422 A1
(43) Pub. Date: Aug. 15, 2013

(54) HEATED SEAT FOR A VEHICLE

(71) Applicants: Brittany Potton, Marquette, MI (US); John D. Cox, Clarkston, MI (US)

(72) Inventors: Brittany Potton, Marquette, MI (US); John D. Cox, Clarkston, MI (US)

(21) Appl. No.: 13/755,049

(22) Filed: Jan. 31, 2013

Related U.S. Application Data
(60) Provisional application No. 61/596,898, filed on Feb. 9, 2012.

(51) Int. Cl. B60N 2/56

(52) U.S. Cl. CPC B60N 2/5685
USPC 297/180.12

(57) ABSTRACT

A heated seat for a vehicle that includes a heat element including at least one wire arranged in a predetermined pattern to substantially cover a cushion of the seat. The at least one wire includes a plurality of portions of varying resistance, wherein the plurality of portions of varying resistance are arranged in a configuration that corresponds a pressure distribution exerted on the cushion by an occupant of the seat.

### CROSS REFERENCE TO RELATED APPLICATION

This application claims the benefit of U.S. Provisional Ser. No. 61/596,898, filed Feb. 9, 2012.

### FIELD

The present disclosure relates to a heated seat for a vehicle and, more particularly, to a pattern for a heat element of the heated seat.

### BACKGROUND

Vehicle seats may include a heating element therein for providing heat to the occupant of the seat. The heat is provided by supplying electric current to a conductor located in the seat that has sufficient resistivity to ensure the desired amount is emitted from the conductor. The conductor, in the form of resistance wires, is located on a layer of textile or a plastic material to provide a carrier in the form of a planar or flat sheet. The resistance wires are fixed in position on the carrier and then positioned between various layers of material to form the heating element that can then be incorporated into a seat. The resistance wires are generally provided in a pattern that evenly covers the carrier so that, when the carrier is provided in the seat, the seat is subsequently evenly heated along an entire surface thereof.

### SUMMARY

A heated seat for a vehicle that includes a heat element including at least one wire arranged in a predetermined pattern to substantially cover a cushion of the seat. The at least one wire includes a plurality of portions of varying resistance, wherein the plurality of portions of varying resistance are arranged in a configuration that corresponds to a pressure distribution exerted on the cushion by an occupant of the seat.

Further areas of applicability of the present disclosure will become apparent from the detailed description, drawings and claims provided hereinafter. It should be understood that the detailed description, including disclosed embodiments and drawings, are merely exemplary in nature, intended for purposes of illustration only, and are not intended to limit the scope of the invention, its application, or use. Thus, variations that do not depart from the gist of the invention are intended to be within the scope of the invention.

### DRAWINGS

FIG. 1 is a perspective view of a seat assembly including a pair of heating elements in accordance with a principle of the present disclosure;

FIG. 2 is a cross-sectional view of a conventional seat cushion or seat back member;

FIG. 3 is a perspective view of a conventional heating element used in a seat cushion or seat back member;

FIG. 4 is a perspective view of an exemplary heating element that may be used in a seat cushion member according to a principle of the present disclosure;

FIG. 5 is a perspective view of another exemplary heating element that may be used in a seat cushion member according to a principle of the present disclosure; and

FIG. 6 is a perspective view of an exemplary heating element that may be used in a seat back member according to a principle of the present disclosure.

### DETAILED DESCRIPTION

Referring to FIG. 1, a vehicle seat assembly 10 is shown, which includes a seat cushion member 12 and a seat back member 14. Seat cushion member 12 includes a heat element 16 that serves to heat the posterior of an occupant sitting in the seat assembly 10. Similarly, seat back member 14 includes a heat element 17 that serves to heat the back of an occupant sitting in seat assembly 10.

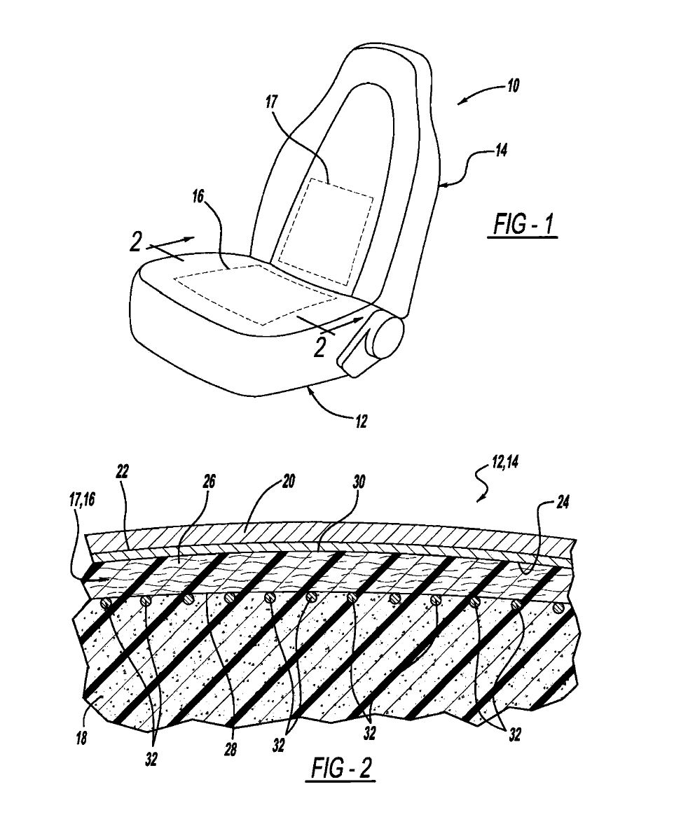

As best seen in FIG. 2, seat cushion and seat back members 12 and 14 may each generally be made of a foam material, such as polyurethane or any other foam material known to one skilled in the art. Seat cushion and seat back members 12 and 14, therefore, may each include a core portion 18 formed of the foam material. Heat element 16 may be formed between core portion 18 and outer cover sheet 20 of seat cushion and seat back members 12 and 14.

To secure heat element 16 between outer cover sheet 20 and core portion 18, an adhesive layer 22 may be used to securely bond heat element 16 to the inner surface 24 of an outer cover sheet 20. Outer cover sheet 20 may be a thin plastisol skin, such as vinyl plastisol, vinyl drysol, butadiene styrene, or other known foam impermeable material. If desired, cover sheet 20 may be formed of a fabric material or a leather material having a plastic backing so as to render it impermeable to the foam material that constitutes core portion 18 of seat cushion and seat back members 12 and 14.

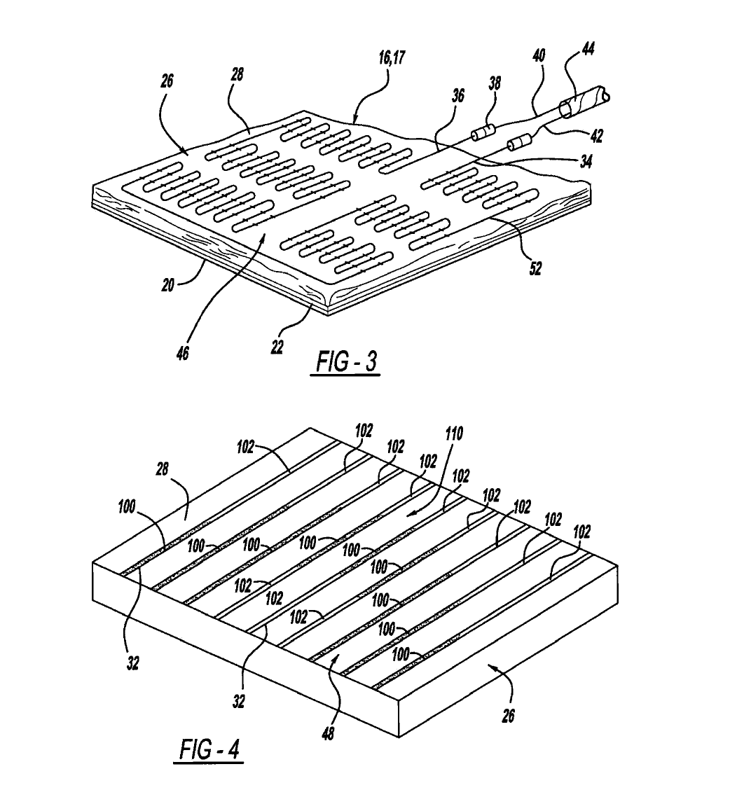

As best illustrated in FIG. 3, heat element 16 includes a generally rectangular carrier member 26 in the form of a web-like foam having a network of open cells throughout its entire flexible body. Carrier member 26 includes an upper planar surface 28 and a lower planar surface 30. Upper planar surface 28 serves to fixedly support an electric resistance wire 32 which has a pair of ends 34 and 36, each of which is respectively connected by a connector 38 to conductors 40 and 42 located in an electric cable 44.

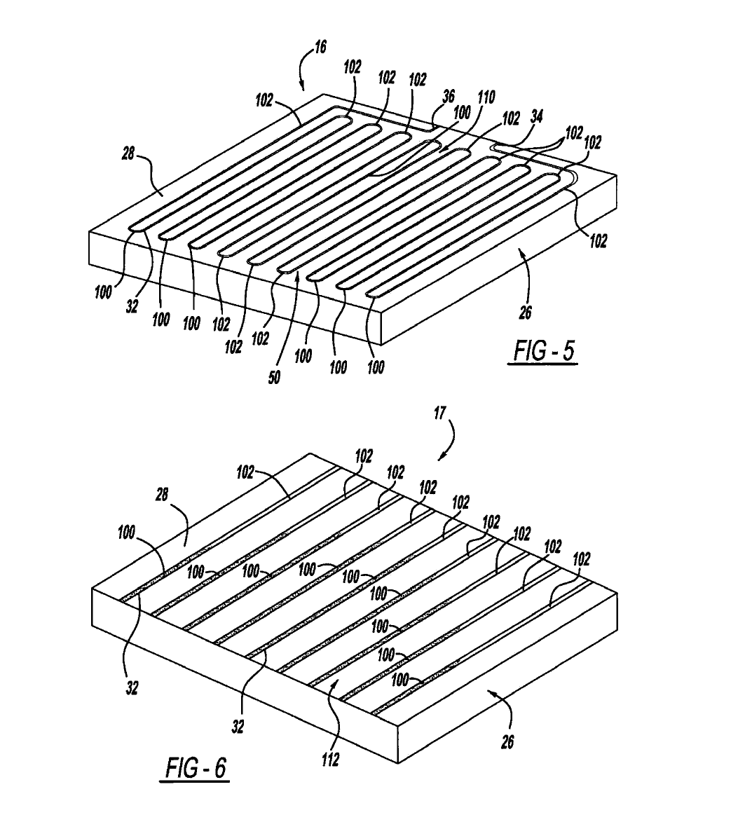

As illustrated in FIG. 3, resistance wire 32 may be arranged in a zig-zag pattern 46 so as to cover most of the area of the upper planar surface 28 of carrier member 26. Resistance wire 32, however, may be arranged on carrier member 26 in any pattern desired. That is, although resistance wire 32 is illustrated in FIG. 3 as being arranged in a zig-zag pattern 46, the present disclosure should not be limited thereto. Rather, in contrast to a single resistance wire 32 arranged in a zig-zag pattern 46, a plurality of resistance wires 32 may be arranged in a linear pattern 48 across carrier 26 (FIGS. 4 and 6). Alternatively, resistance wire 32 may be arranged in a serpentine pattern 50 (FIG. 5), or a plurality of the resistance wires 32 may be arranged to form a web or net-like pattern (not shown). Regardless which pattern is selected for resistance wires 32, it should be understood that resistance wires 32 should be arranged in a manner that covers substantially the entire upper planar surface 28 of carrier member 26.

When resistance wires 32 are arranged in a manner that covers substantially the entire upper planar surface 28 of carrier member 26 and a current is applied to resistance wires 32, seat cushion and seat back members 12 and 14 are evenly heated over an entire surface thereof that corresponds to heat elements 16 and 17. Unfortunately, when seat cushion and seat back members 12 and 14 have an occupant therein, a uniform heat is not experienced by occupant even when resistance wires 32 are arranged in a pattern that evenly covers carrier member 26. In contrast, occupant experiences increased heat at the highest pressure points (e.g., along the occupant's posterior, legs, and lower back), and lower amounts of heat at the lowest pressure points (e.g., areas that surround occupant's posterior, legs, and lower back, and the area between the occupant's lower back and shoulders) that are exerted on seat cushion and seat back members 12 and 14. That is, when the current applied to resistance wires 32 is evenly distributed throughout heat element 16, the amount of heating experienced by occupant increases according to the pressure distribution that the occupant exerts on seat assembly 10.

To account for the differences in pressure that an occupant's body places on seat cushion member 12, resistance wires 32 according to the present disclosure include portions 100 and 102 having varying resistances. More particularly, portions 100 are low-resistance portions 100, while portions 102 are high-resistance portions 102. Referring to FIGS. 4 and 5, for example, low-resistance portions 100 are positioned throughout patterns 48 and 50 in a predetermined pattern or configuration 110 that corresponds to the highest pressures that an occupant's body places on seat cushion member 12. In this regard, the configuration generally corresponds to the outline of an occupant's legs and posterior when seated on seat cushion member 12 (e.g., the configuration 110 is U- or V-shaped).

By positioning low-resistance portions 100 throughout patterns 48 and 50 at positions that correspond to the highest pressure distributions that an occupant will exert on seat cushion member 12, occupant will experience less heat when resistance wires 32 are energized by a current running therethrough. That is, low-resistance portions 100 produce less heat when energized due to the lower electrical resistance thereof. Accordingly, by positioning low-resistance portions 100 in a configuration 110 that corresponds to the general outline of an occupant's body, the occupant will experience a more uniform temperature throughout seat cushion member 12 because less heat will be distributed at the maximum pressure points, and more heat will be distributed at the minimum pressure points.

Such a configuration 110 also enables heat element 16 to draw less current over the entire surface thereof because a maximum amount of current is not required in low-resistance portions 100 to provide an even heat distribution over seat cushion member 12. Accordingly, in addition to providing a more comfortable experience for occupant, heat element 16 also utilizes less energy that conventional heat elements.

To provide low-resistance portions 100, resistance wires 32 may be formed of multiple materials that have different conductivities. Alternatively, resistance wires 32 may be formed of a single material, and the high-resistance portions 102 may be formed from resistors that interconnect low-resistance portions 100. Regardless, it should be understood that portions 100 of lower resistance yield less heat than portions 102 of increased resistance when a current is passed through heat element 16. Although less heat is produced in low-resistance portions 100 that are positioned in areas where the most pressure is exerted by occupant, the occupant will still experience an even heat distribution. That is, the heat felt by an occupant at high pressure distribution regions is related to the pressure exerted on the seat cushion member 12. Even though less heat is produced in low-resistance portions 100, the occupant feels like more heat is being generated in these regions due to the pressure exerted in these regions by the occupant's body. In contrast, although more heat is generated in high-resistance portions 102, less heat is experienced by the occupant in these regions because less pressure is exerted by the occupant's body on these regions. Accordingly, there is an inverse relationship between heat generated at the low-resistance portions 100 and the heating experienced by the occupant at the high pressure distribution regions (i.e., although less heat produced at the low-resistance portions 100, the occupant still experiences increased heat due to the pressure exerted on the seat).

It should be understood that configuration 110 of low-resistance portions 100 and high-resistance portions 102 is determined prior to manufacture of heat element 16. Configuration 110 may be based on multiple pressure distribution measurements taken from multiple occupants having varying sizes to ensure that a majority of occupants experience even heating through use of configuration 110. Further, it should be understood that additional portions may be developed in addition to portions 100 and 102. More particularly, one skilled in the art will appreciate that intermediate-resistance portions (not shown) may be utilized in addition to low- and high-resistance portions 100 and 102. Further, other portions having different resistivities may be used and are contemplated.

Similar to heat element 16, heat element 17 formed in seat back member 14 may also be formed of resistance wires 32 having low-resistance portions 100 and high-resistance portions 102. It should be understood that although resistance wires 32 are illustrated as having pattern 48 (e.g., linearly arranged), the present disclosure should not be limited thereto. Rather, resistance wires 32 of heat element 17 may have any configuration desired by one of skill in the art.

The positions of low- and high-resistance portions 100 and 102, however, will have a configuration 112 different from heat element 16. In this regard, the positions of low- and high-resistance portions 100 and 102 may be configured according to the average pressure distribution that an occupant's back and shoulders exerts on seat back member 14. That is, low-resistance portions 100 will predominantly be located at positions that correspond to an occupant's lower back, while high-resistance portions 102 will predominantly be located at regions that correspond to an occupant's upper back and shoulders. This is because an occupant's lower back generally is an area of increased pressure distribution on seat back member 14, while an occupant's shoulders and upper back are an area of decreased pressure distribution.

Notwithstanding, even though less heat is produced in low-resistance portions 100, the occupant feels like more heat is being generated in these regions due to the pressure exerted in these regions by the occupant's body. In contrast, although more heat is generated in high-resistance portions 102, less heat is experienced by the occupant in these regions because less pressure is exerted by the occupant's body on these regions. In another embodiment, the predetermined resistance configuration may non-symmetrical when viewing the pattern in a plan view, taken exterior of the seat (bottom or back). For example, there may be a greater concentration of low resistance areas in the seat bottom closer to the seat back compared to the concentration of low resistance areas in the seat bottom closer to the front of the seat, proximate the occupant knee region. This greater concentration area accounts for the occupant's lower region weight/pressure and the weight/pressure contribution of the occupant's upper region such as chest and shoulders. The same non-symmetrical pattern principle may be applied in certain embodiments to the seat back to account for regions of varying occupant pressure when seated.

What is claimed is:

1. A heated seat for a vehicle, comprising:
a cushion; and
a heating element disposed within said cushion, said heating element including at least one wire that includes a plurality of portions of varying resistance, said plurality of portions being arranged in a predetermined configuration that corresponds to a pressure distribution asserted on the seat by an occupant.

2. The heated seat of claim 1, wherein said portions of varying resistance include at least a first zone having a first resistance and a second zone having a second resistance.

3. The heated seat of claim 2, wherein said first resistance is greater than said second resistance.

4. The heated seat of claim 3, wherein said second portions are arranged in said predetermined configuration to correspond to regions of highest pressure in said pressure distribution.

5. The heated seat of claim 1, wherein said pressure distribution is U-shaped.

6. The heated seat of claim 1, wherein said wire is arranged in a serpentine pattern.

7. The heated seat of claim 1, further comprising a plurality of wires each having a plurality of portions of varying resistance, and the plurality of portions for each wire collectively being arranged in the configuration that corresponds to the pressure distribution asserted on the seat by the occupant.

8. The heated seat of claim 7, wherein the plurality of wires are arranged in a linear pattern.

9. The heated seat of claim 1, further comprising a second heat element disposed in a seat back cushion of the seat, the second heating element including a second wire that includes another plurality of portions of varying resistance, the another plurality of portions being arranged in another configuration that corresponds to a pressure distribution asserted on the seat back cushion by the occupant.

10. A heated seat comprising a heat element including at least one wire arranged in a predetermined pattern to substantially cover a cushion of the seat, the at least one wire including a plurality of portions of varying resistance, the plurality of portions of varying resistance being arranged in a configuration that corresponds to a pressure distribution exerted on the cushion by an occupant of the seat.

11. The heated seat of claim 10, wherein the wire is arranged in a serpentine pattern.

12. The heated seat of claim 10, wherein the wire is arranged in zig-zag pattern.

13. The heated seat of claim 10, wherein the portions of varying resistance are arranged in a U-shaped configuration.

14. The heated seat of claim 10, wherein the portions of varying resistance are provided by portions of the wire having different resistivities.

15. The heated seat of claim 10, wherein the portions of varying resistance of the wire include low-resistance portions and high-resistance portions.

16. The heated seat of claim 15, wherein the low-resistance portions are arranged to correspond to regions of the seat where high pressures are exerted by the occupant.

17. The heated seat of claim 15, wherein the high-resistance portions are arranged to correspond to regions of the seat where low pressures are exerted by the occupant.
